(19) United States
(12) Patent Application Publication
(10) Pub. No.: US 2003/0177378 A1
(43) Pub. Date: Sep. 18, 2003

(54) Apparatus and method for the decryption of an encrypted electronic document

(76) Inventor: Erland Wittkotter, Buende (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/071,544

(22) Filed: Feb. 9, 2002

Related U.S. Application Data
(63) Continuation of application No. PCT/EP01/06263, filed on Jun. 1, 2001.

(51) Int. Cl. H04L 9/00; G06F 12/14

(52) U.S. Cl. 713/193; 380/282

(57) ABSTRACT

Apparatus for decrypting of an encrypted electronic document by means of a key data file that is introduced or delivered from a server over a public data transmission network, preferably the Internet, whereby the decrypted electronic document is displayable on a local data processing appliances, which comprise a visualization unit or representation unit that enables an outputting of the unencrypted electronic document and which comprise a decryption unit that is used for combining or joining the encrypted document and the key data file for generating the decrypted document, characterized in that the decryption unit comprise in the state, which is capable for accomplishment, at least one function unit that is technically changeable by means of a program, which is capable to be configured by selecting of a key data file from a plurality of local or server sided available key data files or is capable to be configured by the performing of a necessary operation procedure of the decryption unit used for the combination or integration in the generating of the decrypted document or used for the configuration of a specific accessing on a server sided address that is comprised by a key data file and a decryption operation of the decryption unit is influenced in a manner, that only with a predetermined configuration of the function unit the combining or integrating in the decryption unit lead to the correct decrypted document, and whereby the predetermined configuration the function unit is installed or established with at least a single online-contact of the local data processing appliance with the server and which comprise a parameter setting of the function unit resp. decryption unit or an assignment of a program files resp. command components to the decryption unit or comprise a generating of the functions- or decryption unit.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

The present invention concerns an appliance for the decryption of an encrypted electronic document as set forth in the classifying portion of claim 1, as it is known in the German patent application 196 23 868 or PCT/EP97/03113 of the applicant.

### DESCRIPTION OF THE RELATED ART

In this publication to the state of the art in particular a procedure for accomplishing a task or object is described in order to achieve an improved protection of copyrightable valuable electronic document thereby, so that foremost by an online contact with a server-sided server unit a required key data file is introduced for the decrypting and then by effect of a decryption unit that is appointed on the local data processing unit a linking of these key data file with (already available or as well externally received or introduced) encrypted volume data can be achieved by a decrypting and (re-) producing or establishing of the original, usable electronic document.

With regard to the necessary server contact these known apparatus already possess a quite good and effective protection against an access by unauthorized persons (in the following also called hackers), whereby the content-regarding encryption foremost described in these state of the art is distinguished by a particular high measure on security against illegal access to the encrypted electronic document resp. to the electronic document to be encrypted.

### FIELD OF THE INVENTION

However it could be proven as necessary in particular in the case of an elevated security demand or need that the security of such a known apparatus (resp. of a corresponding method) has to be improved additionally, in particular facing the background that by the known one-to-one-relation between encrypted (volume data) file and key data file as well otherwise known decryption algorithm, that anytime the decryption as well as the unrestricted redistribution of the decrypted document in addition is always possible by unauthorized persons, in particular if for instance a operation system level of the corresponding data processing appliance is immediately accessible, or if beside the volume data file the key data file, which is even unencrypted, is additionally accessible. In particular this shows here the difficulty of the reliable protection of key data files, immediately when the local data processing appliance is offline.

### BRIEF SUMMARY OF THE INVENTION

Therefore object of the present invention is to improve a known appliance, that create a generic apparatus and that is used for decrypting of an encrypted electronic document with regard to its protection against unintentional, unauthorized access (in particular in offline operation) and in particular to produce an apparatus, that a hacker does not possess the possibility or circumstances, even after a single, successful attack on an encrypted document, that in the following coming attacks, an unrestricted access and distribution of these document is achievable.

The object is solved by the apparatus with the features of the claim 1; independent protection is claimed for a method according to claim 17, which is suitable in a preferred realization as well as an operation method for the apparatus according to the main claim. Advantageous development of the invention is described in the related, dependent claims.

Therefore according to the invention the function unit, which is capable to be manipulated, it enables the decryption unit to influence the content and even to form the key data file by a suitable configuration of the functionality of the decryption unit. These statement represent the actual core of the present invention: In development of known decryption method, which in other words is usually combined or integrated together with known, invariable operations of a encrypted file with a corresponding key data file and in this manner the requested, usable or applicable result is generated or created, whereby the present invention is additionally offering the possibility or circumstances, so that the intension to raise the protection the manner of operation (e.g. the algorithm or operations), which are required for the decryption, can be manipulated and therefore be operationally prepared. Correspondingly it enlarge the traditional decryption step “Combining or integrating of the key data file with the encrypted file” with the additional step of configuration, setting resp. parameterization of the function unit, which is capable to be manipulated, so that for instance in the producing or enabling a functionality (which is essential for the decrypting) can be based on the decryption unit, so that if in particular the actual decrypting (combining or integrating) of superposed operations can comprise like for instance a suitable key data file that is selected from a plurality of key data files.

Therefore also the term “program technical manipulability” or “technically changeable by means of a program” is interpreted and explained in the framework of the present invention broadly: It does not only comprise a corresponding parameter setting of the function unit (which is typically for instance by the pretending of corresponding, variable control commands used for the manipulability of the same and which can occur within the encryption process), also “program technical manipulability” or “technically changeable by means of a program” comprise the function unit as (program technical) module in the framework of the decryption unit that can be attached, deleted, changed or modified.

In accordance to the invention an appointed manner such a configuration is generated by at least one single online-contact, so that these additional methods that are determining the decryption remains under control of a server (which is connected over the data transmission network), so that the possibility or circumstances for controlling the person entitled to the electronic document is not only possible over the key data file (resp. the manner of the supply), but it is additionally determined by the configuration—according to a preferable development it is determined in a document-specific, furthermore preferable client specific manner, i.e. it is depending on the given local data transmission network. In other words, the traditional one-dimensional focusing on the key is enhanced with the invention to a second runtime- resp. procedure dimension, in other words to the process of the decryption by itself.

As shown in the problem situation provided by the state of the art the vulnerability against attacks is according to the generic methods mainly located in offline-operations, i.e. subsequently the local data processing appliance of the server connection was separated and since the key data file is located locally (encrypted or unencrypted) on the local data processing appliance. In the framework of the present invention these problem is overcame by the additional manipulability of the functionality of the decryption apparatus, whereby in particularly these is configurable in at least one single online contact, for instance in the beginning of a session, however thereafter the advantageous protection effect have mainly an effect in the offline operations. Variants of the “at least one single online-contact” in the meaning of the invention would be for instance in an online-contact that occurs only in the (first) installation of the decryption unit on the local data processing appliance (and in these relation for instance a multitude of function units can locally be stored for a later selection also), alternatively it is also possible to provide a decryption dependency from a permanent online-contact. Generally it is contained moreover according to the development of the invention that these online-contact even operate within an encrypted context, i.e. in particular the function unit, configuration data etc. has been sent by the server unit and has been encrypted in a suitable manner.

A particular simple realization of the present invention clarify these arguments impressively; in other words if the so-called semantic encryption is introduced as a in particular effective encryption procedures, as for example disclosed from the German patent application 199 32 703 resp. PCT/EP 00/06824 of the applicant (regarding to the encryption procedure it should furthermore be included completely as part of the invention within the present application). The basic idea of these semantic encryption is that the meaning of electronic files can be changed easily so that these are not recognizable on the first glace, in other words by operations of interchanging, exchanging, replacing, deleting or attaching of content components (e.g. of words or sentences in a text), so that an (encrypted) result occur as a text again, which is readable and provide seemingly a meaning, and however it differs according to the content of the unencrypted original text and it is in this respect not usable. However for the unauthorized accessing person (attacker) it cannot just be recognized that a semantically encrypted document has actually (still) to be regard as an encrypted document, and not for instance as the unencrypted document that were already requested by him before. If in the framework of the invention a (semantic) key is not provided only in form of a single key data file, but a plurality of keys, that however will not lead to all the actual correct results, but is generated in a seemingly correct, however a content-related exceptional decryption result, the attacker is confronted with an unambiguity problem: Typically a great number of these encryption measures could lead to a (seemingly) meaningful result, as a result of the non-mathematical principals used in the semantic encryption it is however not determined or even proved without further information (in the view of an attacker) in order to decide, which decrypted version is the correct one.

Hence in the framework of the present invention a particular suitable embodiment consist therein that the function unit that is technically changeable by means of a program is developed in a way that these unit is able to select the correct one from a plurality of seemingly usable key data files, so that before the actual decryption process occurs (in other words the correct combination or integration of key data file and encrypted volume data file) a security increasing selection step is occurred by the function unit for a required predetermined configuration given by an online-contact. Accordingly in the practical realization of the invention the semantic encrypted (volume-) data will serve with the correct reconstruction instructions as a key data file, but also together with a plurality of incorrect reconstruction instructions (as further key data files). Thereby it exist a multitude of possible reconstructions that lead to a plurality of possible and seemingly meaningful decryption results, so that the actual correct one is however restricted only on one of the selected key data files by means of the function unit according to the invention.

Thereby the reached ambiguousness resp. missing security or certainness on the site of an unauthorized accessing person that he has really decrypt the correct result is offering therefore a substantial security increasing effect on the present invention.

According to the preferred development of the present invention it is proposed that according to the invention a visualization or representation unit is realized as (e.g. HTML-, Visual Basic-Script-, JAVA-, JavaScript-enabled) browser, whereby in that case it is additionally preferable so that the decryption unit according to the invention is realized as a plug-in for these browsers. In these relation it is proposed in particular that the protocols HTTP, Biztalk (XML), SOAP etc. are used for the management, delivering, transporting etc. of the key data file and/or of the volume data file.

In the practical realization of the function unit this can be proposed in different ways as well: On one hand it is possible to realize the function unit within one or several program libraries (for instance as .dll in a windows system environment), whereby a configuration of the function unit is then realized as a file by a corresponding delivering or introducing (for instance by the online-contact) by such a program module. Supplemental, additionally or alternatively the decryption unit could possess an addressable, controllable or manageable interface as function unit by means of a suitable programming- or script language, whereby the configuration occur by corresponding program- or script commands and in which the decryption unit and consequently the decryption process are influenced.

In particular in the framework of a preferred embodiment of the invention a constellation is conceivable also, in which a program file possess a double function, in other words the execution is carrying out in a corresponding configuration of the decryption process (e.g. a setting of a decryption mode, for instance on the basis of the sequence of decryption commands that are used to realize the decryption), and additionally even instruct operations that are essential for the decryption (in this respect it is additionally working as a key data file also).

A particular preferred embodiment of the present invention is located therein that for the decryption of a (preferred semantic) encrypted document a plurality of key data files are necessary: As an additional functionality of the decryption unit (in other words by suitable configuration) it is not only the task to provide a solution for the selection of these plurality of required key data file from a larger multitude of additional keys; furthermore for a concrete decryption the selected key data files has to be ordered in a required sequence.

According to a further development the security of the present invention has in this way additionally to be improved, so that the complexity of each participating unit and partner is furthermore increased: Therefore it is then for instance preferably not only (distinctly) to design more key data files, which are actually needed for a concrete decrypting (with the purpose that the unauthorized accessing person is additionally be confronted with the task of finding the correct selection), additionally it is comprised in the present invention that a plurality of (changing, i.e. configurable) function units will not all be needed in the preferably same manner as the correct decryption (reconstruction) codes: Also with this the present invention reveal the necessity for the improving of security against an unauthorized accessing person, so that the correct function unit has to be identified and to be activated, in other words this functionality will really enable the intended decryption. Within these development, this means the providing of a plurality of function units are different in its functionality for each, it has in particular been proved, that the functionality is not made recognizable by simple file access data (like for instance in the case of an openly readable commands which may be realized in a script language); moreover it is proposed accordingly to a further development, that this is comprised in a binary data format or like that, which aggravate additionally the classifying and the understanding of a function unit (in the view of an hacker).

According to a further, preferred development, which is capable to prevent or prohibit in a particular elegant manner the manipulation resp. the generating of function units with in the framework of the invention by unauthorized user, it is appointed that the function unit or units of the decryption unit are supplied with a digital signature resp. such a (otherwise known) one-way function within or acting on the function unit (in a concrete examples e.g. on the corresponding program library). Since a manipulation of these function unit may occurs by an illegally accessing person, e.g. because he is trying to (re-) produce properly the decryption operation by a self generated program library, therefore these advantage embodiment of the invention would determine a non-conformity of the decryption unit by creating the digital signature on the (incorrect) function unit and could accordantly output an error message, cancel the decryption process and/or start a further suitable measure for the defense against an attack, whereby further preferably this is done in a non-immediately apparent manner with respect to its execution or temporal relation of the decryption operation. This in particular could also be included and followed by an outputted hint or an indication to the accessing person, that the result of the decryption process is incorrect, and that a renewed decryption is necessary (with accordance to the invention and its appointed configuration of the function unit).

Therefore in the result the present invention enable a further increasing of the security of known decryption processes, in particular on the basis of the semantic encryption, and in order to an additional dimension, in other words it enables to supplement the manipulation of the functionality of the decryption (resp. the decryption function).

### BRIEF DESCRIPTION OF THE SEVERAL VIEWS OF THE DRAWING(S)

Further advantages, features and details of the invention will be apparent from the following description of preferred embodiment and with references to the drawings; these are showing in:

FIG. 1: a schematic block diagram with the apparatus for decrypting of an encrypted electronic document according to a first embodiment of the invention and

FIG. 2: an alternative embodiment of the present invention.

### DETAILED DESCRIPTION OF THE INVENTION

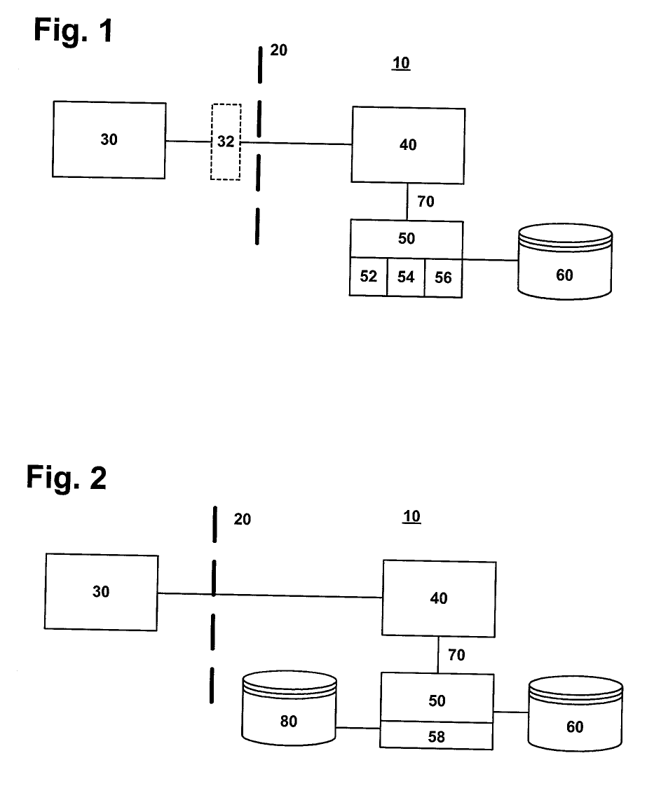

A local data processing appliance 10 shown in FIG. 1 is over an otherwise known Internet connection (schematically shown as 20) connected with a document- and/or key server unit 30 (over a facultative appointed proxy unit 32, which in particular can be arranged for identification-/authorization purposes and for the examination of access rights of an accessing person), on which the available browser unit 40 is communicating in the local data processing appliance (PC) 10 as visualization or representation unit in according generic known manner with the server unit and in particular after successful authorization (or another necessary procedure for the decryption that is used for the transfer of the necessary key data file) from the server unit 30 so that the PC is receiving the necessary key data file for decrypting. By means of a decrypting unit 50 the received key data file with data of the encrypted document (volume data) can therefore be brought together by the server unit 30, and stored in a volume data storage unit 60 in order to be returned on the browser 40 for the representation. More precisely for these purpose the key data file flows over a connection 70 between browser unit 40 and decryption unit 50, which are received by the server unit 30 as well as the data are generated right after the reconstruction of the encrypted document occurs.

However as in FIG. 1 is additionally shown, the decryption unit comprise three function components 52, 54, 56, whereby each one is realized as a program library of the (a program that is calling by the browser unit 40 of an executable) decryption unit and the decryption unit is necessary for a properly functional operation.

However in the framework of the described embodiment the decryption unit 50 is configurable, so that (selectively) the function unit 52, 54, 56 is able to be activated or deactivated by replaceable units that are externally delivered preferably by the server unit 30 and/or by parameter specifications or settings that can be adjusted, so that the correct reconstruction of the volume data contained in the storage unit 60 are not only dependable of the correctly introduced key data file, but additionally of the function unit 52, 54, 56 that have to be correctly implemented in the framework of the decryption unit, so that these are working on the corresponding assigned task or object within the decryption process.

This is explained in an operational example of the embodiment according to FIG. 1: It will be assumed that in the volume data storage unit 60 a semantic encrypted text document is available, in other words, in which the meaning disfiguring encryption is achieved by an exchanging, interchanging, a replacing, a deleting and a attaching of words and sentences (without the necessarity that the developed, encrypted volume document its seemingly losing its meaning). The task that are required for the reconstruction of the original text form, in other words information about the exchanged, replaced, attached and/or removed component, are part or constituent of the corresponding key data file, which were introduced by an authorized user in otherwise known manner of the server unit 30 (that is acting as a key server), in order to link or to combine these data by means of the decryption unit 50 right after it has been called by the browser unit 40. In this example it is assumed that the function unit 52 is arranged with the operation of exchanging, the function unit 54 is arranged with the function of replacing, and the function unit 56 is arranged with the function of inserting and with removing functions as well. However if now the function unit 56 is directly deactivated for improving the security within the framework of the present invention (maybe it is not even available, but it has to be introduced as a program module resp. program library from the server unit 30, or if in the other manner it can not be executed in its functional ability as it was designed), so that namely a partly processing of the key data file occur (which a hacker obtains by an unauthorized access, for instance with a direct storage access), however this processing is not belonging to the inserted and/or removed content components of the document. In the result it arises in the view of a hacker a seemingly decrypted document, however it is still one, which is not corresponding with the original, unencrypted document and so that it is usable.

A complete, correct decryption is in comparison possible by additional—lead over the delivering or introduction of the correct key data file—the function unit 56 is properly configured, either with a corresponding program module for the integration in the decryption unit that will be introduced over the network as well, or over a (server sided and authorized) command that is activating a locally already available unit 56 in its properly operation. (Alternatively also a suitable one from a multitude of locally available (stored) program module could be selected, activated and could thereby be included or contained).

Therefore a hacker has the problem, beside the determining or ascertaining and the acquiring of the key data file, to guarantee additionally a correct functionality of all function components of the decryption unit that are participating in the decryption process function component of the decryption unit, which in particular is further aggravate thereby, so that—as provided according to a further development—also here the setting resp. configuration measures may be regarded as document-specific (therefore each decrypted document is distinguished), and for instance may be regarded additionally as client-specific (i.e. for different operation environments of the local data processing appliance 10 the measures are distinguished), and/or in successive decryption processes (on the same or on identical documents) are always changed basically, so that each illegal decryption success in any case are temporarily and would be limited on a single procedure only. In the development of this starting point it can furthermore be designed, that generally a decryption process (resp. even a document access on the protected document according to the invention) has to be secured temporarily, in a way, that essentially after expiration of a predetermined period of time (e.g. measured in access time by a user) a new configuration of the decryption unit is necessary, consequently also a (new-) decryption may be necessary. Accordingly after expiring of the predetermined period of time the electronic file is changing its composition in a manner that these new decryption is necessary (after newly configuration of the function unit).

Referring to FIG. 2 a second embodiment of the invention is now described; identical reference number or signs are corresponding in this respect to equivalent units of the first embodiment in FIG. 1.

The embodiment shown in FIG. 2 is distinguished from the first one, thereby a function unit 58 of the decryption unit 50 possess the task or objective (and accordingly has to be configured), a selection has to be taken from a plurality of key data files (that are received from the server unit 30 and that are locally stored in a key storage unit 80), whereby in an embodiment only one is correct from a multitude of files stored in the unit 80, so that a corresponding volume data file (from the unit 60) is correctly decrypted; in these case the decryption unit 50 receive additional information (i.e. configuration) over the Internet 20 from the server unit 30 within the framework of the invention, on which of the plurality of received and local stored key data files is the correct one. If this introduced or delivered information is missing within a development each decryption attempt with arbitrarily files that are stored in the unit 80 would lead to a (seemingly correct) result, however the hacker remains in any case in uncertainty, whether he is working with the correct decryption result and as illustrated above its verification, evidence or proof without this additional information is not possible.

Related to a development of the embodiment according to FIG. 2 it is furthermore necessary for the decryption process of the volume document that not only one key data file can be utilized, but from the plurality of the key data files several has to be selected, which has to be regarded in a suitable (correct) sequence for the decryption process. Thereby a suitable configuration of the function unit 58 within the framework of the decryption unit 50 could be based therein, so that for instance a script (received by the server unit 30) that is used for the controlling and managing of the units 50, 58 is selected at least once so that the required, correct key data files from the unit 80 is loaded, but then it is taken in the correct sequence of the decryption, and finally then the actual combining or integrating is occurring with the therein contained reconstruction instruction together with the volume data.

Particular preferable in these embodiment is the assignment to the reconstruction files—e.g. in the case of a text document—it can be done in a page specific manner, whereby the mathematical operations of the cyclic permutations is used in this situation, so that the required correct sequence is established before the combination or integration with the volume data file occur.

By additional measures, for instance the providing of redundant (resp. functional differently operating) function units the complexity may increase almost arbitrarily, with the result that the decryption for an illegally accessing person can lead to a frustrated procedure with a definite effect of discouragement.

The present invention comprise moreover numerous references to further, protective right application of the applicant (with regard to the each discussed technologies resp. solution complex its disclosure should be regarded as included to the present invention in the same manner as in the present application): Therefore the German patent application 199 53 055 resp. PCT/EP00/10750 of the applicant is providing a formulation, in which in particular the commands and protocol for the communication between server unit and local data processing unit can additionally be secured by deconstruction measures and its following (server-sided) reconfiguration. This starting point is easy transferable on the present application also.

Accordingly it is proposed to transfer the starting point known from the German utility application 200 00 957 of the applicant, which offer a server-sided diversion for the additional protection of the Internet-connection, on the present invention and so that in particular the connection between the unit 30 and 40 is additionally secured. According to a further preferred embodiment of the invention as described in the German application 200 03 844 of the applicant, it could be designed that the locally appointed data storage units (60, 80 in FIG. 1, 2), in particular a storage unit (80) used for the storing of the externally introduced key data file has to be regarded as local file server unit, which then can be addressed with suitable, typical protocols.

1. Apparatus for decrypting of an encrypted electronic document by means of a key data file that is introduced or delivered from a server over a public data transmission network, preferably the Internet,
whereby the decrypted electronic document is displayable on a local data processing appliances, which comprise a visualization unit or representation unit that enables an outputting of the unencrypted electronic document
and which comprise a decryption unit that is used for combining or joining the encrypted document and the key data file for generating the decrypted document, characterized in that
the decryption unit comprise in the state, which is capable for accomplishment, at least one function unit that is technically changeable by means of a program, which is capable to be configured by selecting of a key data file from a plurality of local or server sided available key data files or is capable to be configured by the performing of a necessary operation procedure of the decryption unit used for the combination or integration in the generating of the decrypted document or used for the configuration of a specific accessing on a server sided address that is comprised by a key data file
and a decryption operation of the decryption unit is influenced in a manner, that only with a predetermined configuration of the function unit the combining or integrating in the decryption unit lead to the correct decrypted document,
and whereby the predetermined configuration the function unit is installed or established with at least a single online-contact of the local data processing appliance with the server and which comprise a parameter setting of the function unit resp. decryption unit or an assignment of a program files resp. command components to the decryption unit or comprise a generating of the functions- or decryption unit.

2. Apparatus as set forth in claim 1, characterized in that the visualization or representation unit is realized as browser and the decryption unit is used by a plug-in in the browser, or the decryption unit is integrated in the browser, or the decryption unit is arranged as an approachable local server unit on the local data processing appliance, or a function unit on the local data processing unit is connected for instance called over a Intranet-connection belongs to the decryption appliance of the remote data processing unit.

3. Apparatus as set forth in claim 1, characterized in that the function unit is realized as a program library of the decryption unit or a visualization or representation unit, as executable file or as command line or element of the decryption unit on an operation system platform of the local data processing appliances that is preferably managed or realized by a programming- or script language and in particular by means of a digital signature, that is formed on the function unit and that is capable to recognize that an execution operation of the decryption unit, is correct, not manipulated or properly known and thereby capable to be evaluated in a result influenced manner.

4. Apparatus as set forth in claim 1, characterized in that the encrypted electronic document is realized by means of a encryption procedure, in which the encrypted document and the key data file are generated from the decrypted document that correspond to original amount of data, which comprise a sequence of information component of a meta language in form of a written language, a number system or information components from a predetermined uniform format structure of arranged or ordered data elements, in particular image-, sound- or program information, that data elements are stored in a plurality of electronic addressable storage areas and that the encrypted document is generated by following operations:
Exchanging or removing of an information component in the amount of data or attaching of an information component at a predetermined position in the sequence of information components or replacing of an information components against a preferred information component that is not contained in the original amount of data not contained,
whereby the key data file comprise specific information about the exchanged, removed, inserted, attached or interchanged information component and is thereby arranged in manner that a reconstruction of the original amount of data is permitted.

5. Apparatus as set forth in claim 4, characterized in that the decryption unit is realized as a reconstruction unit, so that the processing of the encrypted amount of data and the key data file is arranged for generating of the decrypted document.

6. Apparatus as set forth in claim 4, characterized in that each encrypted document is assigned to a plurality of usable key data files by the decryption unit, whereby at least one is usable to generate the decrypted electronic document, and at least one is usable to generate a document that is for a user seemingly correct, however which is not arranged or designed as the correct decrypted document that is corresponding to the electronic document.

7. Apparatus as set forth in claim 1, characterized in that for generating of the decrypted document a plurality of key data file is necessary.

8. Apparatus as set forth in claim 1, characterized in that the necessary operation procedure that is used for the combination or integration for the generation or creation of the decrypted document comprise the selecting of a key data file from a plurality of key data files or comprise the producing of a sequence of successive decryption steps or comprise the needed key data files used for the combination or integration.

9. Apparatus as set forth in claim 1, characterized in that the predetermined configuration is designed in a document specific manner, in particular after expiring of a predetermined period of usage time a decrypted electronic document requires a renewed decryption after renewed configuration.

10. Apparatus as set forth in claim 1, characterized in that the predetermined configuration is dependent from the local data processing appliance and in particular specifically designed or arranged for the appliance.

11. Apparatus as set forth in claim 1, characterized in that the decryption unit is designed or arranged in an manner that a repeated or new decryption of the encrypted document occurs by means of a configuration of the function unit, which differ from the configuration of a foregoing decryption process and in particular is influenced by operation or status data of the foregoing decryption process.

12. Apparatus as set forth in claim 1, characterized in that the decryption unit is assigned to a plurality of function units, whereby the decryption unit comprise the configuration, the selecting of one of the function units and its assigning to a decryption operation.

13. Apparatus as set forth in claim 12, characterized in that the corresponding function unit from the plurality of function units is different with regard to its effect on the decryption operation of the encryption unit and which are preferably realized as binary files resp. modules.

14. Apparatus as set forth in claim 1, characterized in that the key data file is realized as an executable program, which is acting as a function unit of the decryption unit, whereby in particular information for generation of the decrypted document arises from interactions between components, internal variables or other program parameters of the executable program and are acting on the encrypted document.

15. Apparatus as set forth in claim 1, characterized in that the electronic document is selected from the group, which consist of audio-, music-, video-, program-, multimedia-, animations-, 3D-, text-, image- or game files.

16. Apparatus as set forth in claim 1, characterized in that server sided of a server unit comprise a proxy unit that is installed in front of the server unit, which is approachable or callable by function of the function unit and which execute an identification or authentification process of the called local data processing appliance, in particular for comparing document related usage right of the user on the local data processing appliance with the server sided introducible or deliverable key data files.

17. Method for decrypting of an encrypted electronic document by means of a key data file that is introduced or delivered from a server over a public data transmission network, preferably the Internet, in particular method for operating the apparatus as set forth in claim 1,
whereby the decrypted electronic document is displayable on a local data processing appliances, which comprise a visualization unit or representation unit that enables an outputting of the unencrypted electronic document
and which comprise a decryption unit that is used for combining or joining the encrypted document and the key data file for the generating of the decrypted document, with the steps:
transmitting of the key data file partly or completely over the data transmission network,
transmitting of at least one predetermined function unit of the decryption unit as file, command components or script over the data transmission network to the local data processing appliance,
activating of the decryption unit,
decrypting of the encrypted document by electronic processing of a data stream that is corresponding to the key data file or to the encrypted document by means of the predetermined function unit and
displaying of the decrypted document by means of the visualization or representation unit.
